(19) United States
(12) Patent Application Publication
(10) Pub. No.: US 2009/0234489 A1
(43) Pub. Date: Sep. 17, 2009

(54) Fitting Systems

(76) Inventor: Jodi Healy, Sutton, MA (US)

Correspondence Address: Jennifer D. Tousignant, 4 Main Street, Westford, MA, 01886, US

(21) Appl. No.: 12/351,851

(22) Filed: Jan. 11, 2009

Related U.S. Application Data
(63) Continuation-in-part of application No. 11/372,396, filed on Mar. 9, 2006.
(60) Provisional application No. 60/660,031, filed on Mar. 9, 2005.

(51) Int. Cl. G06F 19/00; A41H 3/00

(52) U.S. Cl. 700/130; 33/17 R

(57) ABSTRACT

The invention relates to methods that correlate individual size-related measurements provided by a consumer to specifications of articles offered by a manufacturer or a business. The correlation enables a consumer to determine whether a specific article is appropriate for a particular consumer's size and/or fit needs. Size-related measurements or article specifications may be stored in a database. Articles include items such as clothing, footwear, outer wear. Individuals may be animals or persons.

### CROSS-REFERENCE TO RELATED APPLICATION

This application is a continuation-in-part of U.S. Non-Provisional Patent Application Ser. No. 11/372,396 filed Mar. 9, 2006, which claims priority under 35 U.S.C. § 119(e) to U.S. Provisional Patent Application Ser. No. 60/660,031, filed on Mar. 9, 2005, the contents of which are hereby incorporated by reference into the present disclosure

### FIELD OF THE INVENTION

The invention relates to methods to fit articles to an individual's physical body.

### BACKGROUND OF THE INVENTION

Individuals routinely select articles to be worn on their bodies using sizes provided by manufacturers or retailers. These sizes, however, fail to reflect the complexities associated with the fitting of two and three dimensional articles to an individual's body. Standard sizing does not does not account for the uniqueness and variances of an individual's body. It is broad and general. Even in the same market, a size label utilized to indicate a particular size for one manufacturer may be identical to that utilized by another, but may represent a different actual fit.

Also, in the growing global markets, the labels utilized to indicate size may not be common or understood by individuals seeking to shop outside of their typical markets. For example, European shoe sizes are represented by numbers such as 35, 36, 37, 38, etc. while United States shoe sizes are represented by numbers such as 5, 6, 7, and 8. Additionally, the labels utilized to indicate size in one country or region may be identical to those used in another, but may not represent the same size. An example may be found in the United States sizing system as compared to the British sizing system, where a size 12 likely represents different sizes or fits.

In addition, there are instances in which the sizes are specific to a certain discipline. In this case, an individual seeking to select an article may know the physical measurements to which the article must match but does not know how to correlate the measurements to the appropriate size with which the article is traditionally related. For example, a person may seek to fit a blanket to a horse of a specific height, body length, and body depth. However, blanket sizes are typically labeled 76, 78, 80, etc. This leaves the individual with little certainty as to the fit of any specific blanket without trying a specific size.

Fit-related issues are one of the primary reasons that consumers, particularly when shopping online, return articles of clothing. Therefore, a need exists in the art to provide a means to solve the issues associated with fit as well as those associated with selecting appropriate sizes for individual body measurements. The instant invention provides a solution to these issues and others. It offers a means by which an individual will know what size or article to select without having to try the article on.

### SUMMARY OF THE INVENTION

The invention relates to methods that correlate size-related measurements of individuals to specifications of articles provided by, for example, a manufacturer or a business. The correlation enables a determination as to whether a specific article is appropriate for an individual's size needs. Size-related measurements or article specifications may be stored in a database. The invention further relates to means to store data related to individual body profiles as well as means to store data related to article specifications comprising measurements relating to the article's dimensions. Articles include items such as clothing, footwear, outer wear. Individuals may be animals or persons.

The size-related or body measurements of an individual may be determined by the individual, by another person, by body scanning technology, or by any means that can determine the points of measure of the individual. Body measurements may also be determined using a process referred to as reverse engineering. Reverse engineering is, in one embodiment, the process of taking a garment's specification or a three dimensional article's measurements from a database comprising such measurements. These measurements are then used to determine body measurements for an individual or individuals by correlating specific measurements of the garment or article to specific points of measure on an individual's body. The reverse engineering system may be used to reverse populate a personal body profile by using measurements of a specific article selected by an individual.

The invention also relates to methods that utilize the correlation of size-related measurements of individuals to specifications of articles in order to search for articles based on the fit of a specific article to an individual. In particular, an individual selects a particular article with a correct and desired fit for said individual. The correct/desired fit may be known because the individual currently has the article or has physically worn the article at some time. In addition, the correct fit may be known because the methods of the instant invention have determined the correct fit by comparing the individual's measurements to the article's specifications with the use of a correlating means that connects the two sets of measurements. Once a specific article is selected by an individual, the instant invention utilizes a correlating means to search at least one database of article specifications for articles with similar specifications/measurements as the specific article upon which the search is based. In this way, an individual, who prefers a particular style, design or cut of a specific article such as a pant, may use this known preference to search for additional articles of similar cut, design, and/or style.

The fitting system may store the information comprising the specification and/or measurements of an article with a correct, or “favorite” fit of a particular individual. This may be utilized in combination with an individual's rating of a particular article. Once stored, whether determined via rating or another means, the fitting system may be utilized by an individual, to search in article databases for articles similar to the favorite fits, wherein the articles would be a suitable fit the individual with whom the favorite fit is associated. In another embodiment, the fitting system may determine and report recommendations to an individual based on a favorite fit profile. The fitting system via a correlating means connects the database comprising the favorite fit information and the database comprising article specifications and determines those articles with a similar fit to the favorite fit.

In another embodiment of the instant invention, an individual, who prefers a particular style, design, or cut of a specific article, may use the known preference plus at least one additional characteristic to search for additional articles of similar cut, design, and/or style that have the additional characteristic. The additional characteristic may be a characteristic such as color, material, fabric, type, price, manufacturer, brand, availability, season, or activity. The ability to search by a characteristic is determined by the nature of the information that may be provided as a search characteristic of the article.

The instant invention also comprises the use of a fitting system to validate the fit of an article, such as an article of clothing or a pair of shoes, for an individual interested in determining whether or not the article is the correct fit. Fit validation comprises comparing the measurements or specification of a selected article to the measurements of the interested individual via a correlating means in order to determine whether or not said selected article is the correct fit for the individual. The article measurements or specifications and the individual's measurements may be present in a database comprising such measurements. If the correlating means determines that a selected article is the correct fit, the system so indicates. If the instant algorithm determines that a selected article is not the correct fit, the system so indicates. Validate fit of a selected article here

The instant invention may provide the information generated by the methods of the instant invention in a report form such as the report in FIG. 3. The report may comprise information relating to the appropriate size of a selected garment or article that represents the correct fit, to the results of a search by fit here, to the results of a search by fit and at least one characteristic, or to the results of a fit validation.

The fitting system of the instant invention, including the embodiments described above, may also be combined with a system that permits a manufacturer or retailer or other third party to provide additional information to the individual using the fitting system. For example, an individual may have selected an article of clothing with the proper fit using the instant fitting system via an online retailer or via an in-store kiosk. A third party may provide information to the individual regarding additional articles that may coordinate with the selected article, are similar to the selected article, are in the same price range as the selected article. The additional information may be any type of information selected by a third party. Use of any of the above plus input of additional suggestions from manufacturer/retailer/etc

### BRIEF DESCRIPTION OF THE FIGURE

FIG. 1 provides a flow chart that represents an embodiment of the fitting system provided by the instant methods.

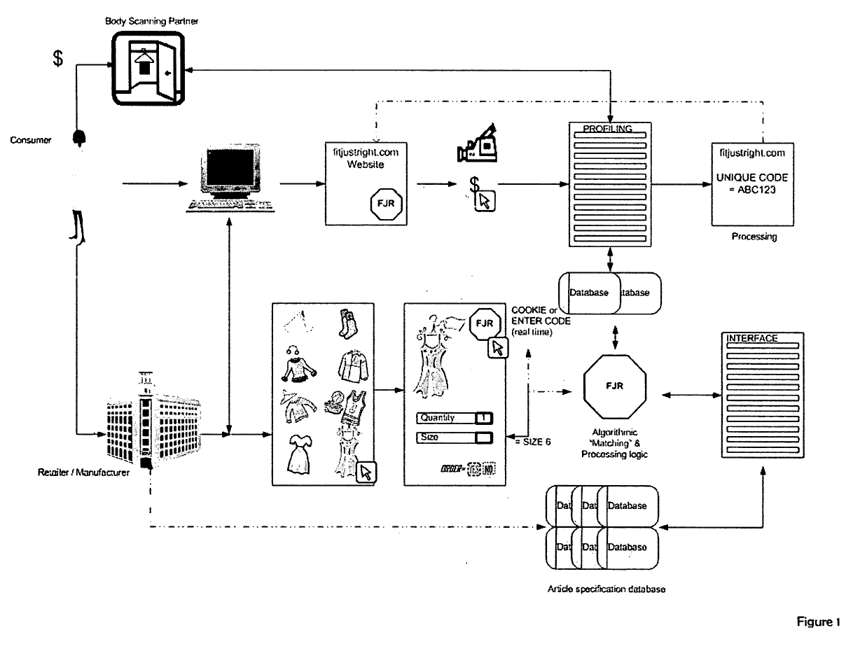

FIG. 2 provides a chart that represents a point of measure profile for an individual, which comprises the individual's personal body profile.

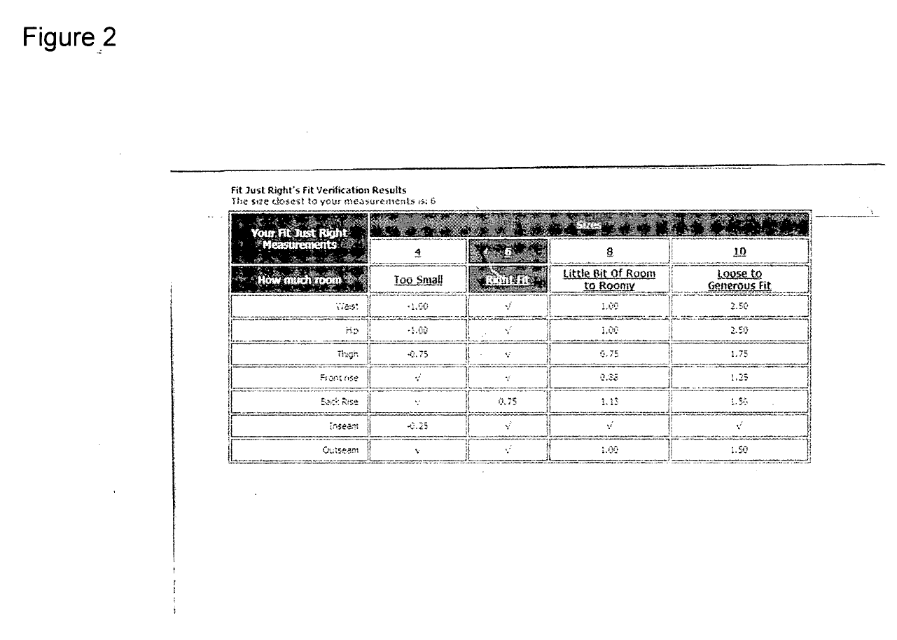

FIG. 3 provides an example of a fit guide and verification results report, which comprises information relating to the appropriate size of a selected garment or article representing the correct fit for an individual using the instant methods.

FIG. 4 provides a table of individuals for whom personal body profiles have been generated. This may be used by one individual to shop for herself or another individual wherein the correct fit may be determined. These measurements may also be kept private. In one example, this is done so that the individual shopping for a second individual does not know the actual measurements of the second individual but can still find articles with the correct fit for the second individual. If the measurements are not private, by clicking on the name of an individual, a chart representing the point of measure profile for the individual, which comprises the individual's personal body profile, will appear such as that represented in FIG. 2.

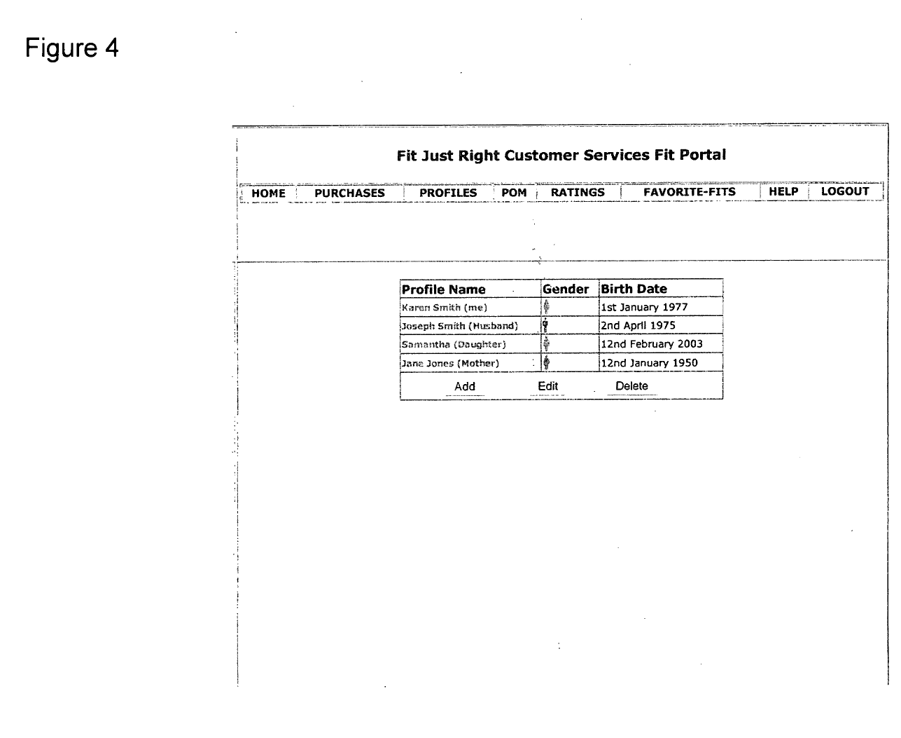

FIG. 5 provides an example of an online table where an individual can enter an identification number for an article, such as a SKU code, in order to validate the fit of the article for a selected individual. Or, the individual can rate the fit of the entered article.

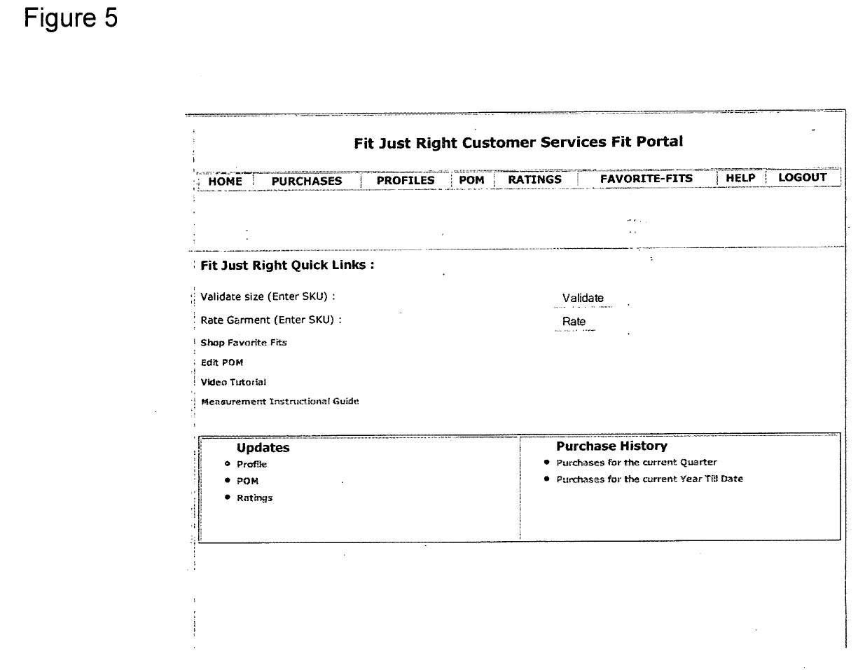

FIG. 6 provides an example of how an individual may rate the fit of a particular article wherein the rating may be stored in order to educate future article selections, be used to shop for future article selections, or be stored as a favorite fit.

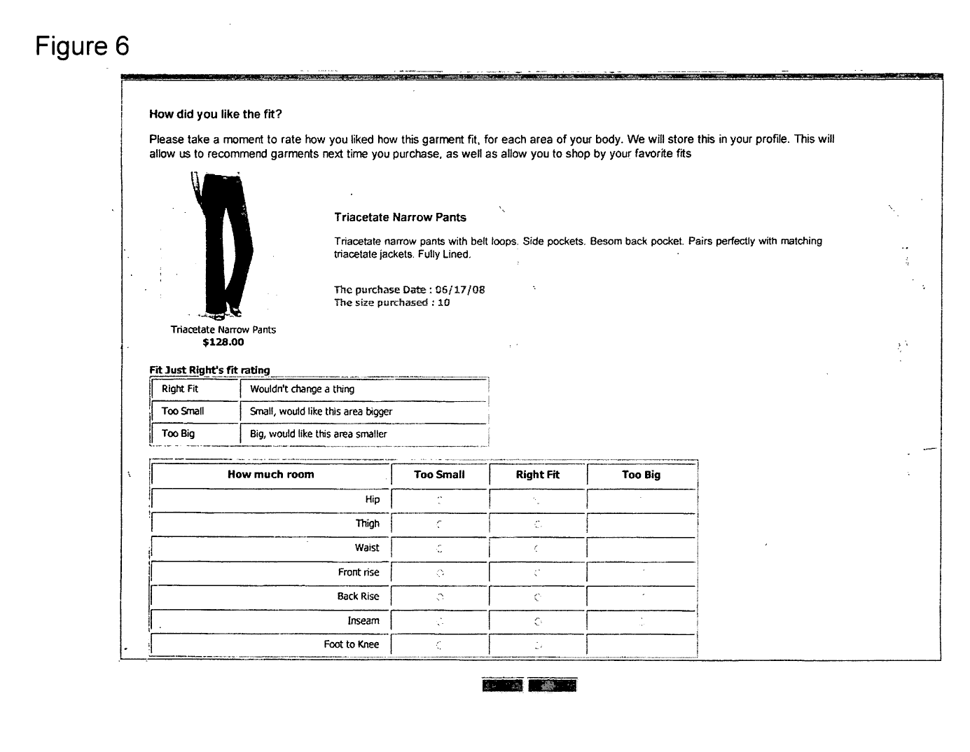

FIG. 7 represents a selection of articles stored in a database, wherein an individual associated with the articles may rate their fit via a rating tool such as that represented in FIG. 6. For example, the articles may represent the purchase history of an individual or the favorite fit of an individual. Rating of the fit of the articles may be done multiple times, if the fit on the individual changes. The information represented may be utilized for future matching, searching to enable the purchase of an article with a similar fit and/or silhouette.

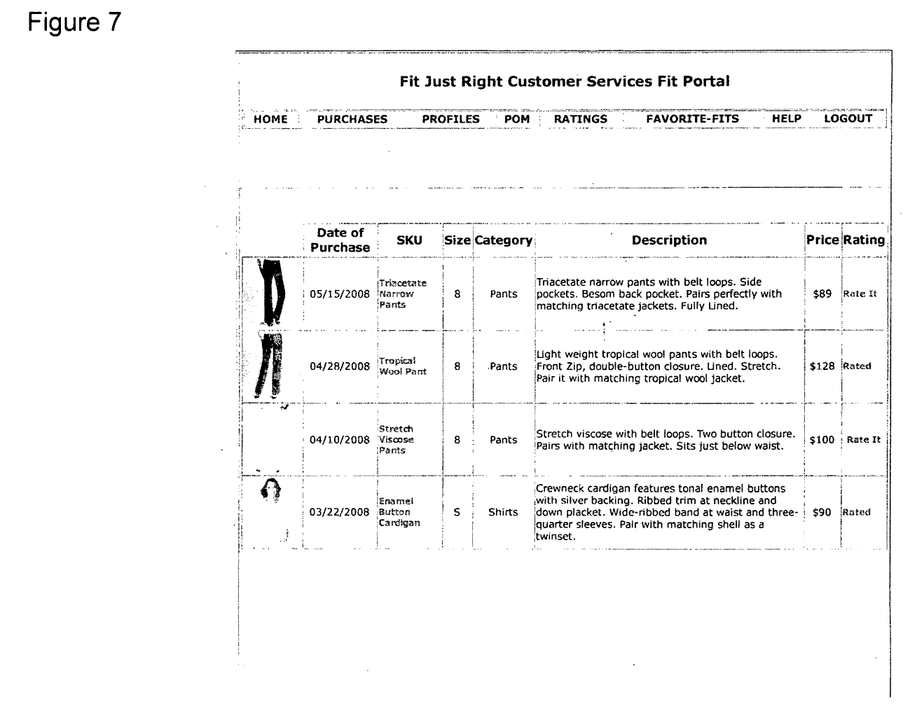

### DETAILED DESCRIPTION OF THE INVENTION

The instant invention, in certain embodiments, bridges a gap that exists between individuals seeking certain articles and manufacturers or retailers offering the sought after articles. It offers a means by which an individual may select articles with ease and minimal effort because the fitting system enables the selection of articles based on measurements customized to the individual.

The instant invention helps to solve the online and in store demand for easily accessible article and fit information while delivering both shopping convenience and personalized customer service. For example, once an individual creates a personal body profile, the individual may use the instant methods to shop online, in a retail store, or through a catalog. The instant methods may validate the fit of articles and provide fit information on any article, including without limitation clothing and shoes, selected by an individual using the individual's personal body profile. The instant invention may also search for and recommend articles with the correct fit for an individual.

The invention utilizes an individual's body measurements, preferences, ratings, and stored favorites to create a personalized shopping experience.

In another embodiment, the instant invention may provide current data to manufacturers or retailers regarding their consumer base. The databases of the instant invention provide this data. One such database comprises the individual body measurements determined by said individuals, entered into a data processing means, and processed for storage. For example, one hundred thousand body profiles, which represent 100,000 individuals, may be stored in a database. A manufacturer or retailer may then access the information to determine how to alter production to more closely reflect the article size requirements of the consumer base. In one embodiment, the database is designed to interact with the correlating means of the instant invention. In another embodiment of the invention, the database comprises data that has been processed so that the individual body measurements have been associated with a unique identifier code. In one embodiment, the database is designed to interact with the correlating means of the instant invention.

Another database of the instant invention comprises article specifications determined by manufacturers or retailers. These specifications comprise measurements specific to an article's dimensions. Once a database is established, the stored information may be updated to reflect changes in article specifications. It is envisioned in one embodiment that a database would be updated frequently to reflect a manufacturers or retailers currently offered articles.

In one embodiment, the database is designed to interact with the correlating means of the instant invention.

The databases of the instant invention may be hosted by the article producers, a third party, or the service provider.

The instant invention is drawn to methods that enable individuals to select articles of an appropriate size based on individualized measurements. One embodiment of the instant invention relates to an online body profiling service comprising an entry form and database that hosts an individual's personal body profile. A correlating means will connect to a database comprising article specifications determined by manufacturers or retailers. The correlating means will compare an individual's personal body profile to the article specifications. The comparison results in a match to the correct size of the article in which the individual is interested. The fitting system may also compare the individual's personal body profile to multiple garments, wherein the number is dictated by the correlating means, and provide the results of the comparison to the individual. One means of providing the results is a hierarchical sorting of all garments that fit with the closest fit being at the top of the sort and the furthest fit at the bottom.

The invention also relates to methods that utilize the correlation of size-related measurements of individuals to specifications of articles in order to search for articles based on the fit of a specific article to an individual. In particular, an individual selects a particular article with a correct and desired fit for said individual. The correct/desired fit may be known because the individual currently has the article or has physically worn the article at some time. In addition, the correct fit may be known because the methods of the instant invention have determined the correct fit by comparing the individual's measurements to the article's specifications with the use of a correlating means that connects the two sets of measurements. Once a specific article is selected by an individual, the instant invention utilizes a correlating means to search at least one database of article specifications for articles with similar specifications/measurements as the specific article upon which the search is based. In this way, an individual, who prefers a particular style, design, or cut of a specific article such as a pant, may use this known preference to search for additional articles of similar cut, design, and/or style.

The fitting system may store the information comprising the specification and/or measurements of an article with a correct, or “favorite” fit of a particular individual. This may be utilized in combination with an individual's rating of a particular article. Once stored, whether determined via rating or another means, the fitting system may be utilized by an individual, to search in article databases for articles similar to the favorite fits, wherein the articles would be a suitable fit the individual with whom the favorite fit is associated. In another embodiment, the fitting system may determine and report recommendations to an individual based on a favorite fit profile. The fitting system via a correlating means connects the database comprising the favorite fit information and the database comprising article specifications and determines those articles with a similar fit to the favorite fit.

For example, an individual may rate her favorite fit/style of jeans using the rating system portion of the fitting system, wherein the rating information is stored as a favorite fit. The individual may then indicates that jeans searches are performed exclusively using this favorite fit information. Based on this indication, the fitting system may enable the individual to receive recommendations from manufacturers or retailers or any third party relating to matches to this favorite fit. The recommendations may be via email, via interaction with an online retailer, via personal communications, via postal mail, or via any means of communicating this information to the individual. The matches may be more or less stringent as provided by the correlating means providing the information—it may comprise information related to articles of similar fit profile, new colors, seasons, etc.

In addition, the fitting system may be utilized to search for articles using exclusively an individual's favorite fit information. This may be performed online at the individual's home or in-store using a kiosk. In addition, the fitting system may provide recommendations based on these favorite fits via a correlating means connecting the database comprising the database of favorite fit information and the article database wherein the information generated provides recommendations of articles suitable for said individual based on the favorite information. In this embodiment, the fitting system does not utilize an individual's personal body profile to compare against the article measurements database. It utilizes the measurement information associated with a particular favorite fit. Thus, the fitting system may search for articles using only favorite fit information, which may have comprised a rating, wherein a more focused article selection process occurs. In a retail store, a sales associate may have the articles selected by the fitting in this manner ready for an individual in store upon arrival. The instant fitting system may also inform an individual of new items similar to an individual's favorite fit whether in person, on the phone, or online via a report.

In another embodiment of the instant invention, an individual, who prefers a particular style or cut of a specific article, may use the known preference plus at least one additional characteristic to search for additional articles of similar cut and/or style that have the additional characteristic. The additional characteristic may be a characteristic such as color, material, fabric, type, price, manufacturer, brand, availability, season, or activity. The ability to search by a characteristic is determined by the nature of the information that may be provided as a search characteristic of the article.

The instant invention also comprises the use of a fitting system to validate the fit of an article, such as an article of clothing or a pair of shoes, for an individual interested in determining whether or not the article is the correct fit. Validation of fit may occur, for example, when an individual, who is selecting articles for herself or for another person, electronically stores a list of selected articles via, for example, an online shopping cart.

Fit validation comprises comparing the measurements or specification of a selected article to the measurements of the interested individual via a correlating means in order to determine whether or not said selected article is the correct fit for the individual. The article measurements or specifications and the individual's measurements may be present in a database comprising such measurements. If the correlating means determines that a selected article is the correct fit, the system so indicates. If the correlating means determines that a selected article is not the correct fit, the system so indicates.

In the case that the selected article is not the correct fit, the system may utilize the personal body profile to search for and determine, via a correlating means, the article (of the same type as the non-fitting article) that comprises the correct fit. This article would be displayed to the individual shopper and represents one embodiment of the system's ability to generate fit recommendations for the individual.

Additionally, in the case that the selected article is not the correct fit, the system may search for and suggest an alternative article (e.g. one of similar style or dimensions but not the same article previously selected) via a correlating means comprising a correct fit for the personal body profile utilized by the system in the search. The suggested article with a correct fit would be displayed to the shopper and represents another embodiment of the system's ability to generate fit recommendations for the individual.

The fitting system may also search and deliver recommendations relating to articles with a correct fit to an individual based on the individual's personal body profile or based on stored favorite fits that may been rated or simply stored as a favorite fit. The recommendations may be delivered electronically, personally, by mail, or any means of communication with the individual.

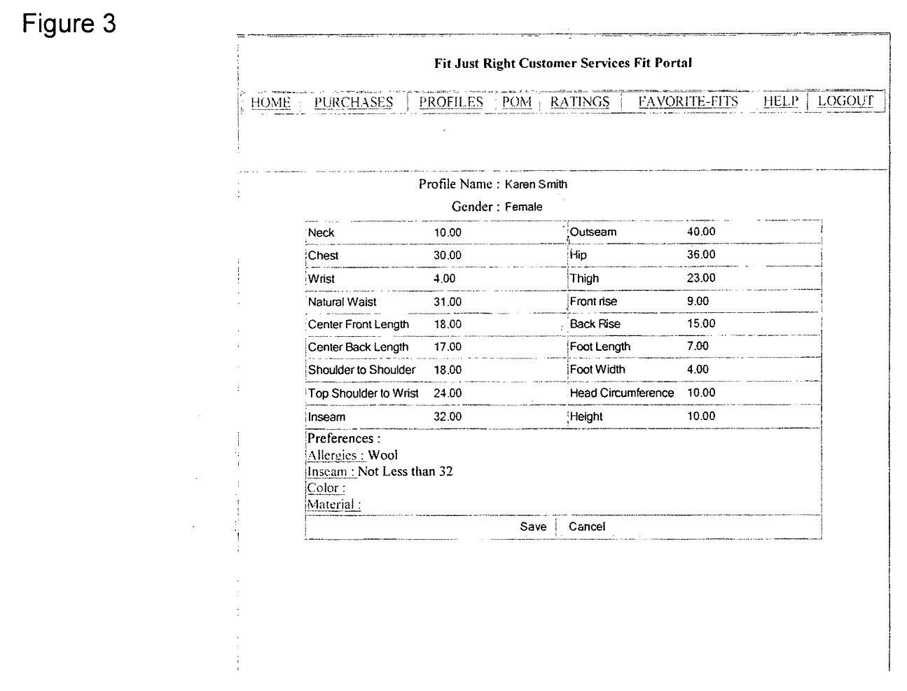

The instant invention may provide the information generated by the methods of the instant invention in a report form such as the report in FIG. 3. The report may comprise information relating to the appropriate size of a selected garment or article that represents the correct fit, to the results of a search by fit here, to the results of a search by fit and at least one characteristic, or to the results of a fit validation.

The fitting system of the instant invention, including the embodiments described above, may also be combined with a system that permits a manufacturer or retailer or other third party to provide additional information to the individual using the fitting system. For example, an individual may have selected an article of clothing with the proper fit using the instant fitting system via an online retailer or via an in-store kiosk. A third party may provide information to the individual regarding additional articles that may coordinate with the selected article, are similar to the selected article, are in the same price range as the selected article. The additional information may be any type of information selected by a third party.

In another embodiment of the fitting system, the system utilizes reverse engineering. In one such embodiment, a specific garment's dimensions and/or measurements may be retrieved a from a manufacturing specification provided by an article manufacturer, a database comprising garment dimensions, or any means in which such measurements are stored. The reverse engineering system may then store the data for the garment relative to a user. This data may be data that represents a favorite fit or style of the individual. Subsequently, the individual may utilize this data to search by fit, wherein the fitting system compares the article measurements that were determined via reverse engineering to the size-related measurements of the individual to search for articles with a fit similar to the favorite fit or style.

The fit data generated via reverse engineering may be used to query article measurement databases in order to search for articles with similar or matching dimensions or measurements. For example, if an individual prefers a particular style of shirt, the measurements of said shirt may be reverse engineered from a database comprising the shirt's points of measure. These measurements may then be associated with the individual, such as in a stored profile, as a favorite fit. This data may then be utilized to find similar shirts for the individual. In addition, the fitting system may comprise a means by which it recommends and identifies to the individual articles with a similar fit to the favorite.

In any search utilizing data generated by reverse engineering, the search may utilize multiple points of measure in any one garment or may utilize a single point of measure for the garment.

A fitting system may also comprise a method wherein an individual may rate the fit of articles whose fit is known to the individual.

In another embodiment, the individual's personal body profile may be represented by a unique identifier code so that the individual only needs to enter the code, rather than the entire profile. The correlating means will connect to 1) a database comprising the processed data wherein the individual body profile is associated with a unique identifier code and 2) a database comprising article specifications determined by manufacturers or retailers. The correlating means will compare an individual's personal body profile as pulled up by the unique code to the article specifications. The comparison results in a match to the correct size of the article in which the individual is interested.

An individual could take the measurements his/herself, could have the measurements representing the personal body profile taken by a third party, or have the measurements taken using body scanning technology known in the art. Once a body profile is established, the stored information may be updated to reflect changes in an individual's profile. For example, individual body changes, may occur in the case of a child developing and aging or as an individual gains or loses weight. The stored information may be updated to reflect changes in and associated with a body profile associated with a unique identifier code.

Body measurements may also be determined using a process referred to as reverse engineering. Reverse engineering is, in one embodiment, the process of taking a garment's specification or a three dimensional article's measurements from a database comprising such measurements. These measurements are then used to determine body measurements for an individual or individuals by correlating specific measurements of the garment or article to specific points of measure on an individual's body. The reverse engineering system may be used to reverse populate a personal body profile by using measurements of a specific article selected by an individual.

A personal body profile may be comprised of pre-selected measurements. The pre-selected set of measurements may be a single measurement or may be a plurality of measurements. They may be pre-selected based on an individual's needs, an article's needs, or a manufacturer's or retailer's needs. Examples of measurements suitable for use in the practice of the instant invention include, but are not limited to: bust, chest, waist, hips, inseam, back to waist length, back width, neck circumference, sleeve length to underarm, and upper arm circumference. Such pre-selected measurements may also include any additional measurements that the individual chooses or that are appropriate for the article.

Articles include any article of clothing, footwear, outerwear, or any other item comprising at least two dimensions capable of being fitted to an individual. Examples include, but are not limited to: pants, shirts, jackets, socks, undergarments, shoes, gloves, hats, sweaters, skirts, dresses, blankets, saddles, bridles, helmets.

An individual may be a human or an animal.

The correlating means of the instant invention may be an algorithm. It may be a software program. Those skilled in the software art or the logic arts may easily develop the correlating means. In one embodiment, the correlating means compares an individual body profile to an article's specifications and selects an article that provides the best size match with the profile. The selected article represents an appropriate fit between the individual and the article. The comparison may vary in its determination of fit. The match may be more or less stringent, depending on the particular correlating means.

In one embodiment, the match may be more stringent, wherein the point of measure of the article is at least the dimension of the point of measure for the individual. For example, an individual's waist measurement is 32 inches. Using a stringent match, an article of clothing will match if its waist point of measure is 32 inches or greater.

In another embodiment, the match may be less stringent wherein the correlating means takes into consideration a tolerance of a certain amount. For example, a correlating means may require a tolerance of one inch in the waist point of measure. Thus, taking the above example, an individual's waist measurement is 32 inches. When the correlating means utilizes a one inch tolerance for the match, a match will only be made if the waist measurement for the article is at least 33 inches, e.g. at least one inch greater than the actual waist measurement of the individual.

The tolerances may be applied by an individual user of a fitting system, may be applied by a service provider of the fitting system, or may be applied by a manufacturer or retailer hosting the fitting system for use by their patrons.

The correlating means may further comprise a means to translate between different measuring systems, for example, between metric and the U.S. system of measurement.

An appropriate fit for a particular individual represents a particular article that matches an individual's profile in the manner defined in advance by the service provider. The appropriate fit may vary based on the type of article.

A manufacturer or retailer is a person, actual or legal, who offers articles to individuals or to other manufacturers or retailers. They comprise a manufacturer, a retail store, or a sole proprietor. The articles may be offered in a physical retail location or online or by mail-order catalog. The nature of the article or the nature of the article offeror does not limit the instant methods.

An exemplary scenario for use of the instant methods can be described as a business to consumer scenario wherein the method is facilitated by a service provider. In this scenario, a manufacturer or retailer partners with a service provider. The manufacturer or retailer accesses the service provider's business through a website portal, which may comprise a graphical user interface. Here, the manufacturer or retailer may enter article measurements that define the physical dimensions of the article offered by the manufacturer or retailer. This entry may be mediated in certain embodiments by uploading data from the manufacturer's databases. The manufacturer may also interface their databases with those of the service provider to provide article measurements. These physical dimensions may be pre-set fields selected for the particular article. They are, for example, bust circumference, chest circumference, waist circumference, hip circumference, back to waist length, back width, neck circumference, etc. These article measurements are stored in an accessible database. The database is likely electronic, although a paper database is possible as well.

A fitting system of the instant invention may be accessible online where a individual may validate the fit of the articles that they have selected, receive fit recommendations for articles from the fitting system, and rate the fit of articles selected by the individual.

The online access may be via a personal computer in an individual's home accessed through a web portal, via a web-enabled kiosk in a store, via a local network enabled kiosk in a store, via a hand-held mobile device, cell phone, PDA, or other. The nature of the access may vary as long as a database comprising a personal body profile may be connected to a database comprising article specifications, wherein a correlating means will compare an individual's personal body profile to the article specifications for the specific purpose desired by the individual. The purpose may be size validation, calculation of fit recommendations, or rating the fit of articles selected by the individual.

An individual may also utilize electronic communication devices, such as hand-held mobile devices, to communicate information regarding fit validation and fit recommendations in a retail store setting. This information may be received by a sales associate, who uses it to provide the individual with articles of the appropriate fit. This enables a sales associate to search for, recommend, assist, bring the right size to the dressing room, or prepare in advance selections to try on or buy in a concierge model, and sell articles specific to an individual customer's measurements and preferences.

The same service provider will also offer a service to individual consumers with which they create a personal body profile. The consumer may access the service provider's services through a website portal, which may comprise a graphical user interface. Here, the consumer may watch an instructional video detailing how to take proper and accurate measurements for a personal body profile. The consumer may then determine the measurements comprising the personal body profile themselves. Optionally, the consumer may have a third party determine the measurement(s), wherein the third party could be a person or a body scanning machine as known in the art. The consumer, or a third party, enters the measurements. The measurements fields may be pre-selected by the service provider. Once the measurements are entered, the service provider uses a processing means to assign the personal body profile a unique identifier code. This code will be associated with the personal body profile and stored with said profile in an accessible database. The database is likely electronic, although a paper database is possible as well. The profile may be updated at any time to reflect changes in the consumer's body.

Once the consumer has been assigned a unique identifier code, the customer may utilize the code to search for articles at manufacturer or retailer partners of the service provider. This is because the service provider provides a correlating means that links the accessible database comprising article measurements to the accessible database comprising the unique identifier code correlated with the personal body profile. The consumer selects an article and enters the unique identifier code. The correlating means accesses the databases, compares the measurements, and selects the article with the correct fit.

Different service providers may create the individual databases connected by the correlating means. In other embodiments, the same service provider creates the databases and provides all the services.

The instant invention may be utilized to select or purchase articles for an individual for whom the personal body profile is created. In other embodiments, the methods may be utilized to select or purchase articles for a third party, wherein the consumer uses the third party's unique identifier to select articles. The unique identifier is not necessarily attached to personal information, providing privacy for the individual while still enabling a third party to select articles for said individual.

In certain embodiments, the instant methods may be used by businesses to select uniforms for their employees.

In other embodiments, the individual body profile data may be interfaced with manufacturing machines capable of producing articles based on the measurements in the profile. This enables the creation of custom clothing in a partially or completely automated fashion.

In another embodiment, global shopping conversions are done automatically by the correlating means of the instant methods. This enables individuals to select articles of non-familiar sizing systems without using conversion tables. This also enables manufacturers or retailers to offer articles in global markets without changing product labels or manufacturing processes.

The fitting system may also comprise, in combination with the above embodiments, a rating system, which allows a user to rate the fit of a garment.

The fit may be rated on a point of measure by point of measure basis by rating the fit of the specific dimensions of a garment by the individual points of measure of the garment. A user can rate a garment's dimensions manually or through an automated form. The rating information can be loaded into a database or stored manually.

The rating can be completed by a person for themselves, another person or animal. The rating can be completed on a garment owned, for sale, being returned, or recently purchased.

The garment is rated using a unique identifier or code to identify the garment (SKU number, or other). The garment dimensions can be manually entered by a user into a database or may be accessed via a manufacturer's or retailer's database. The dimensions of a garment are either a specification or manufacturing dimensions.

The rating can be completed on one or multiple points of measure. The rating can be completed on a manufactured garment, lot of garments, sample size or size of a garment to be manufactured. The rating method can use a unique identifier or code, a numerical rating system, a numerical percentage based rating system, or any other form of system wherein the relative fit or non-fit of a garment could be evaluated.

The rating system can be offered by a retailer, vendor or manufacturer or third party.

The user rates a garment on applicable points of measure that make up the dimensions of a garment. A specific point of measure of a garment is rated by a user to provide unique feedback, assessment or classification on that dimension or point of measure of the garment relative to the individual user's assessment of fit or non-fit. A point of measure is given a unique code by the user. This code is used in a correlative means against the actual garment specification or dimension.

The rating system may be utilized for multiple reasons. In one embodiment, the rating system evaluates an individual's level of satisfaction with the fit of a garment or a preference related to fit. In another embodiment, the rating system evaluates the accuracy of an individual's personal body profile comprising the individual's points of measure by comparing the specification of a garment to at least one of the individual user's body measurement or to multiple points of measure.

In another embodiment, the system may adjust an individual's personal body profile, which comprises the individual's body measurements. The rating system may adjust any one point of measure, or multiple points of measure, based on the individual's rating of a particular garment's fit. For example, an individual may rate a particular point of measure, such as waist dimensions, of a particular article, such as a pant. The rating may be expressed in terms, for example, such as “too small” or “too large”. If the waist of a garment is rated as “too large” by an individual, the system may retrieve the measurement of the pant and, via a correlating means, compare the individual's waist measurement to the garment's waist measurement. If a difference between the two points of measure is determined to exist by the fitting system, an adjustment of the individual's profile may be made, or a query for adjustment may be made. For example, where a “too large” rating is entered, the fitting system may find a difference in the waist of one inch, wherein the individual's waist point of measure is thirty inches but the pant's waist measurement is actually twenty-nine inches. In this situation, a one inch deduction may be made to the individual's waist measurement in her personal body profile. Alternatively, the fitting system may prompt the individual as to whether or not to make the adjustment.

In another embodiment, the rating system may create a personal tolerance to a particular style, cut or design of a garment for a user to be utilized in the fitting system tolerance of the instant invention. A tolerance is a range applied to a particular point of measure that addresses preference of how a wearer likes certain styles or cuts of garment to fit (e.g. yoga pants versus jeans). For example, a tolerance may be an inch, two inches, seven inches, or any quantity of measure deemed appropriate by an individual. By adding or subtracting a tolerance to a person's body measurements, the rating system may apply a preferred tolerance to enable the selection of an appropriate fit of a garment. For example, if an individual prefers her jeans to fit loose in the waist to an extent that the preferred waist is larger than her actual waist dimension, the rating system may account for this preference when the user shops for jeans in the future. This adjustment may be calculated and/or stored as a favorite fit profile for the garment.

In another embodiment, the rating system comprises determining a desired size and style of a future garment by adding or subtracting a desired tolerance based on the individual's rating of any individual point of measure. For example, the rating system may use the information generated when an individual rates a garment to search and find similar garment specifications that have similar measurements as the rated garment.

The rating system may add a personal tolerance or preference to an individual's personal body profile based on how an individual likes her clothing to fit.

In another embodiment, the rating system comprises a means to provide general feedback on a garment's dimension or dimensions to a retailer, manufacturer or vendor. The feedback comprises information on how an individual or a collection of more than one individual rated the fit of a garment by the individual points of measure of the garment or by the overall fit. For example, the rating system may provide information of how one million individuals rated the waist of a particle article “too small” but all other dimensions as accurate on a particular manufactured garment. The party can then adjust the manufacturing dimensions for the waist measurement going forward.

### EXAMPLES

A Prophetic Jeans Purchase:

An individual creates a personal body profile comprising a set of measurements that may include among others: bust, chest, waist, hips, inseam, back to waist length, back width, neck circumference, sleeve length to underarm, upper arm circumference, and any additional measurements that the individual chooses. The individual enters the measurements comprising her personal body profile into a form provided by a service provider. Upon entry of the data by the individual, a service provider processes the data and assigns a personal, unique identifier code to the profile, which represents the individual's personal body profile. The personal body profile, with its associated code, is stored in an accessible database.

A clothing manufacturer or retail store creates article specification profiles for articles offered for sale, such as a pair of jeans known as “B jeans”. For the B jeans offered, the manufacturer or retail store or sales agent will create a profile comprising the size specifications for each size of B jeans that are offered. These profiles are referred to as article specifications. They would comprise measurements relevant in determining the appropriate size for an individual. For example, they may include waist circumference, inseam, hip circumference. The article specifications for the jeans may be stored in an accessible database. This data may be hosted by the service provider in one embodiment. In another embodiment, this data may be hosted by the article manufacturer and the service provider accesses the data through an interface.

A service provider provides a means to correlate the personal body profile created by the individual with the article specifications provided by the B jeans manufacturer or retail store. To enable the individual to select the correct size of B jeans, the individual would enter her unique identifier code into a system provided by the service provider. The correlation means provided by the service provider would then compare the data represented by the individual's unique identifier code to the article specifications provided by the B jeans manufacturer. Following this comparison, the correlation means would then identify the size of B jeans representing the correct fit for the individual.

A Prophetic International Jeans Purchase

In certain instances, the measurement system utilized by the individual may not be the same as that utilized by the manufacturer or retailer. This is likely common where the individual and the manufacturer or retailer are located in different countries. For example, the individual's measurements could be represented by inches or feet while the manufacturer's or retailer's measurements could be represented in centimeters or meters. In this case, the correlation means provided by the service provider would take into account the conversions required to compare the measurements from the two systems.

A Prophetic Example of Reverse Engineering,

An individual enters a unique identifier or code, such as a SKU, to identify a garment. This identifier or code is used to retrieve the points of measure of the article. The garment dimensions may be stored in the user profile for the individual, including storing it associated with a unique identifier, code or classification. Alternatively, the garment dimensions are used in real-time to search for garments in a garment database with at least one similar point of measure to the identified garment or with points of measure similar in all aspects. For example, a user identifies a favorite pair of jeans. The user would like to find jeans that maintain the same fit profile/silhouette and/or the same dimensions or measurements of the favorite jeans. The fitting system queries at least one database comprising jeans specifications or measurements to find and identify to the individual similar or matching jeans to the favorite pair.

A Prophetic Rating Example

A point of measure, such as a waist, is given a unique identifier or code by the individual. The unique identified or code is used in a correlative means against an actual garment specification or dimension. For example, the fitting system may set forth a group of selected ratings for the waist measurement of “too small”, “right fit”, or “too large”. If the individual utilizing the rating system selects a “too small” rating, this classification may mean that the waist dimension of the garment is smaller than the actual waist dimension of the user or that the individual prefers the waist dimension of the garment to be larger than the waist dimension of the user, which is based on the individual's preference as to how the users like the garment to fit. If the individual utilizing the rating system a selects a “right fit” rating, this classification may mean that the dimension of the garment measurement is the same dimension as the user's body measurement, that the dimension of the garment is similar or close to the actual waist dimension of the user, or that the individual simply prefers the difference between the waist dimension of the garment and the users waist dimension-based on preference as to how the individual likes the garment to fit. If a selected rating for waist is “too big”, this classification means that the dimension of the garment measurement is larger than the actual waist dimension of the user or that the shopper prefers the waist dimension of the garment to be smaller in dimension than the waist dimension of the user-based on preference as to how the users like the garment to fit.

We claim:

1. A method comprising:
a) determining a pre-selected set of body measurements specific to an individual;
b) determining a pre-selected set of article measurements specific to an article's dimensions;
c) comparing the measurement specific to the individual with the measurement specific to the article using a correlating means; and
d) determining whether said article is the correct size and/or for said individual.

2. A method comprising:
a) determining a pre-selected set of body measurements specific to an individual;
b) entering said body measurements into a data processing means;
c) processing said body measurements to associate said body measurements with a unique identifier code, wherein said code and associated data are stored;
d) determining a pre-selected set of article measurements specific to an article's dimensions;
e) entering said article measurement into a data processing means, wherein said measurements are stored;
f) connecting the data stored in step c) and step e) via a correlating means;
g) entering said unique identifier code into said correlating means, wherein said correlating means compares the measurement specific to the individual with the measurement specific to the article and determines whether said article will fit and/or match the correct measurements of said individual.

3. A database comprising the measurements in claim 2, step e).

4. A database comprising the code and associated data in claim 2, step c).

5. The method of claim 1, wherein the individual is a human.

6. The method of claim 1, wherein the individual is an animal.

7. The method of claim 2, wherein the individual is a human.

8. The method of claim 2, wherein the individual is an animal.

9. A method comprising:
a) determining a pre-selected set of body measurements specific to an individual;
b) entering said body measurements into a data processing means;
c) processing said body measurements to associate said body measurements with a unique identifier code, wherein said code and associated data are stored;
d) connecting the data stored in step c) to a machine capable of creating an article via a correlating means, wherein said machine creates an article with measurements specific for said individual.
